(19) United States
(12) Patent Application Publication
(10) Pub. No.: US 2015/0268346 A1
(43) Pub. Date: Sep. 24, 2015

(54) OPTICAL AXIS DIRECTING APPARATUS

(71) Applicant: KABUSHIKI KAISHA TOSHIBA, Tokyo (JP)

(72) Inventor: Hiroaki NAKAMURA, Kawasaki Kanagawa (JP)

(73) Assignee: KABUSHIKI KAISHA TOSHIBA, Tokyo (JP)

(21) Appl. No.: 14/662,019

(22) Filed: Mar. 18, 2015

(30) Foreign Application Priority Data
Mar. 19, 2014 (JP) 2014-056575

(51) Int. Cl. G01S 17/66; G01S 7/481; G01S 17/89

(52) U.S. Cl. CPC G01S 17/66; G01S 17/89; G01S 7/4813; G02B 27/1006

(57) ABSTRACT

According to one embodiment, an optical axis directing apparatus includes a base, a lens, a light source, a beam splitter, an image sensor, an image processor, and a galvano scanner. The lens is supported on the base and has a wide viewing angle. The light source generates first light. The beam splitter allows transmission of at least one of the first light traveling to the lens and second light traveling from the lens. The image sensor acquires the second light from the beam splitter and acquires an image of the second light. The image processor receives the image and calculates a position of a feature point included in the image. The galvano scanner receives the first light and defines an optical path along which the first light travels to the position through the lens.

### CROSS-REFERENCE TO RELATED APPLICATIONS

This application is based upon and claims the benefit of priority from Japanese Patent Application No. 2014-056575, filed Mar. 19, 2014, the entire contents of which are incorporated herein by reference.

### FIELD

Embodiments described herein relate to an optical axis directing apparatus.

BACKGROUND

In recent years, more and more measurement systems that measure the position information on a moving target by automatically tracking the target using a laser, and laser tracking systems that emit an illumination beam to a target, have been commercially available. These systems are equipped with an optical system for guiding a laser and a mechanism for directing the axis of the laser. In order to widen the range of application of the laser tracking, these systems have to direct an optical axis in a wide range and yet have to be compact in size.

Many of these types of laser tracking system have conventionally used a gimbal structure to direct an optimal axis in all directions. The gimbal structure is required to have at least two axes. In the case of a 2-axis gimbal, if a target passes through the zenith or the vicinity thereof, the azimuth axis (Az axis) has to be directed from the front toward the rear and therefore has to rotate nearly 180 degrees. Due to the limitations of a motor torque, this operation is hard to attain in practice, resulting in a so-called gimbal lock, i.e., a phenomenon wherein the consecutive tracking cannot be performed. With the 2-axis gimbal structure, the azimuth axis cannot be directed to the vicinity of the zenith, and the target cannot be tracked in all directions.

The conventional laser tracking systems include a system employing a 3-axis gimbal structure. The 3-axis gimbal structure increases a degree of freedom in operation, and prevents an excessive angular velocity by dividing the movements to those on the Az axis and those on the xEL axis (cross elevation axis). With the 3-axis gimbal structure, the gimbal movement is prevented from being beyond the enabled range and the gimbal lock is prevented thereby. In this manner, the target is consecutively tracked, with the optical axis being directed in all directions.

As a method for enabling a laser beam to be directed in a wide range without the gimbal structure, the conventional art has proposed an x-y deflection module comprising a wide-angle lens array and a galvano-mirror driving system.

As a method for enabling a marker to be recognized based on a captured image and directing a laser beam to all over the sky, the conventional art has proposed a structure wherein a projection optical system is provided with a fish-eye lens, a pattern filter and an illumination source, and wherein an optical path dividing element includes a beam splitter.

### BRIEF DESCRIPTION OF THE DRAWINGS

FIG. 1 is a block diagram illustrating an optical axis directing apparatus according to an embodiment.

FIG. 2 illustrates characteristics of incident light from the space to a convex lens.

FIG. 3 illustrates how the relationships between the angle of incidence and the illumination plane are in the equidistance projection conversion system.

FIG. 4 illustrates how the correspondence between the illumination plane and the three-dimensional imaginary spherical surface is in the equidistance projection conversion system.

FIG. 5 is a schematic diagram showing a biaxial galvano scanner.

FIG. 6 is an example of a beam forming unit shown in FIG. 1.

FIG. 7 is an example of an image acquired by an image sensor.

FIG. 8 is a block diagram illustrating a control system used for directing an optical axis to a target.

### DETAILED DESCRIPTION

A detailed description will now be given of an embodiment with reference to the accompanying drawings. In the descriptions set forth below, like reference numerals denote like elements or operations, and a redundant explanation will be omitted. The optical axis directing apparatus of the embodiment is a laser pointing system which guides a beam to a moving object while tracking the moving beam.

According to one embodiment, an optical axis directing apparatus includes a base, a lens, a light source, a beam splitter, an image sensor, an image processor, and a galvano scanner. The lens is supported on the base and has a wide viewing angle. The light source generates first light. The beam splitter allows transmission of at least one of the first light traveling to the lens and second light traveling from the lens. The image sensor acquires the second light from the beam splitter and acquires an image of the second light. The image processor receives the image and calculates a position of a feature point included in the image. The galvano scanner receives the first light and defines an optical path along which the first light travels to the position through the lens.

The conventional art described above has problems in that the control method for attaining downsizing or tracking a target is inevitably complex. For example, in the case of the 3-axis gimbal structure, the number of driving means such as motors increases, and the downsizing and low-cost manufacture are hard to attain. In the case of the 3-axis gimbal structure, moreover, the load inertia on the xEL axis used for installing a camera or the like may be so large as to cause interference with the Az axis, resulting in a problem peculiar to the 3-axis gimbal structure. In addition, although the use of a redundant axis may help reduce the angular velocity about the Az axis, the angular velocity required about this Az axis is larger than those required about the other axes, and the driving torque required must be inevitably large.

The technology for directing a laser beam in a wide range without using a gimbal structure has problems in that it is not applicable to the case where the target irradiated with the laser beam moves. Since the technology is originally intended to project an image (e.g., a computer graphic image) onto a stationary dome-shaped or spherical observation plane, the resolution and intensity on a specific type of observation plane are corrected so that they do not deteriorate in practice. If the observation plane serving as a target to be irradiated moves, correction relationships cannot be maintained.

The technology for projecting light into the space all over the sky in order to recognize a marker based on a captured image has problems in that it is not applicable to the case where the target to be irradiated moves. According to the technology, illumination light made to pass through a pattern filter is then made to travel through a fish-eye lens so that the pattern can be projected all over the sky. Since the space is irradiated with fixed-pattern light, the target cannot be tracked or continuously irradiated with light.

The present embodiment has been attained in an effort to solve the problems mentioned above, and is intended to provide an optical axis directing apparatus which realizes a small-sized laser tracking system and enables automatic tracking of a target all over the sky.

The light axis directing apparatus of the embodiment is designed to position and guide a beam to a target in an arbitrary direction all over the sky. Since the embodiment uses a super-wide-angle lens and a biaxial galvano scanner for directing the optical axis, the driving force it requires is smaller than that of a gimbal structure. Accordingly, it provides a device small in size and light in weight. In addition, since the optical system of the embodiment uses the same super-wide-angle lens for both the illumination system for illuminating a beam from the light source and an incidence system for receiving a beam from an object, the position detection coordinate system of the target and the optical axis positioning coordinate system for directing a beam to the target can be the same. Accordingly, the target can be tracked and illuminated with a beam by means of a simple control system. Furthermore, since the embodiment uses a beam forming unit for beams emitted from the light source, the beams output from the super-wide-angle lens is prevented from widening by adjusting the beam direction of the beams.

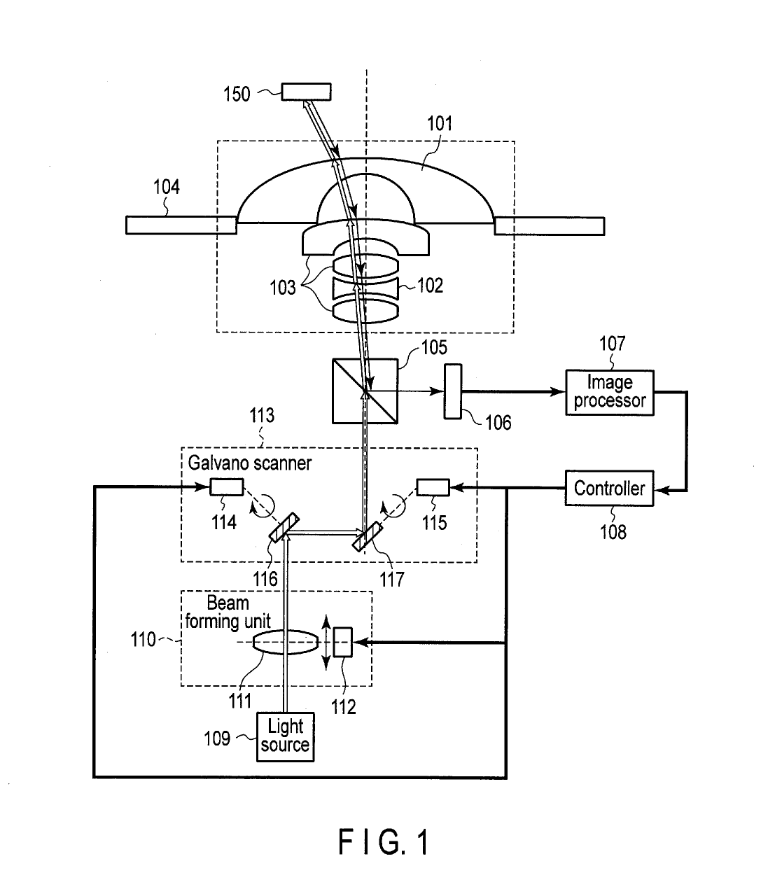

The optical axis directing apparatus of the embodiment will be described referring to FIG. 1. FIG. 1 is a block diagram illustrating an optical axis directing apparatus according to an embodiment.

The optical axis directing apparatus of the embodiment comprises a convex lens 101, a concave lens 102, a correcting lens 103, a base 104, a beam splitter 105, an image sensor 106, an image processor 107, a controller 108, a light source 109, a beam forming unit 110, an aperture lens 111, an aperture controller 112, and a galvano scanner 113. The galvano scanner 113 comprises a first driving unit 114, a first galvano mirror 116, a second driving unit 115 and a second galvano mirror 117.

The convex lens 101 guides a beam emitted from the light source 109 to wide-range space by means of the beam splitter 105. Also, the convex lens 101 receives light reflected by a target 150 in the space or light emitted from the target 150 and permits this light to travel to the beam splitter 105 by means of the concave lens 102. The convex lens 101 is configured to guide a beam to a predetermined position inside the semispherical space or to receive light coming from an arbitrary position inside the semispherical space. The convex lens 101 is also configured to guide a beam to a predetermined position outside the semispherical space or to receive light coming from an arbitrary position outside the semispherical space. The convex lens 101 can be configured to guide a beam to a predetermined position outside the semispherical space or to receive light coming from an arbitrary position outside the semispherical space. It should be noted here that the path of beams output from the optical axis directing apparatus and the incidence path of beams coming from the object 150 are substantially on the same axis. The convex lens 101 is, for example, a super-wide-angle lens, which has a very wide angle compared to that of an ordinary type of lens. The light source 109 is not limited to a particular type as long as it generates and emits light whose wavelength and amount are compatible with the characteristics of the convex lens 101, concave lens 102, correcting lens 103, beam splitter 105 and image sensor 106.

The concave lens 102 converges the light emitted from the light source 109 on the convex lens 101. Conversely, the concave lens 102 diverges the light transmitted through the convex lens 101 by controlling it in a unique projection method and forms an image on the imaging plane.

The correcting lens 103 is a combination of a number of lenses and is configured to correct aberrations. The aberrations are a departure from a perfectly focused image and caused by the optical system. For example, the aberrations includes spherical aberration, asymmetrical aberration (such as coma aberration), astigmatism, field curvature, field deformation, and chromatic aberration.

The base 104 is connected to the apparatus elements described above and configured to support them. In other words, the base 104 serves as a member enabling the optical axis directing apparatus to be installed horizontally. The base 104 supports, for example, the convex lens 101, concave lens 102, correcting lens 103, beam splitter 105, image sensor 106, image processor 107, controller 108, light source 109, beam forming unit 110, aperture lens 111, aperture controller 112 and galvano scanner 113. The base 104 may be configured to secure these members in such a manner that at least one of them is movable.

The beam splitter 105 either permits incident light to pass therethrough or reflects the incident light, depending upon the direction in which the light is incident.

The beam splitter 105 is optically connected to the convex lens 101, image sensor 106 and galvano scanner 113. The optical connection of “A” to “B” is intended to mean that light is incident on “B” from “A” or light is incident on “A” from “B.” The beam splitter 105 permits the light emitted from the light source 109 and reflected by the galvano scanner 113 to pass therethrough and be incident on the convex lens 101. Also, the beam splitter 105 reflects the light coming from the target 150 through the convex lens 101 in such a manner that the reflected light is incident on the image sensor 106. In the present embodiment, the beam splitter 105 is, for example, a transflective member configured to pass infrared light and reflect visible light. The light emitted from the light source 109 and reflected by the galvano mirror 113 is infrared light, while the light incident on the image sensor 106 is visible light. The beam splitter 105 is not limited to this structure. For example, it may be configured to separate infrared light into different components based on frequency differences. In this case, the beam splitter 105 is configured to reflect infrared light within a predetermined frequency range and pass infrared light outside the frequency range.

The image sensor 106 is arranged on an optical path along which light split by the beam splitter 105 travels. The light traveling through the convex lens 101 and the beam splitter 105 is made to incident on the imaging element, so that the image data on the target 150 is captured. The resultant data is supplied to the image processor 107.

Based on the image data received from the image sensor 106, the image processor 107 performs operation processing to obtain image position information in order to recognize the target 150. The image position information represents how feature points of the target 150 are on the image. The operation data, which is image position data obtained by the image processor 107, is supplied to the controller 108. As will be described later with reference to FIG. 8, the image processor 107 calculates position vectors on the orthogonal coordinate system based on the projection conversion relationships of lenses.

Based on the operation data supplied from the image processor 107, the controller 108 generates an angular instruction for the galvano scanner 113 for guiding light to the target 150, and also generates a formation instruction for the beam forming unit 110. The controller supplies the angular instruction to the galvano scanner 113 and supplies the formation instruction to the beam forming unit 110.

The angular instruction is information for determining the angle of the galvano mirrors included in the galvano scanner 113. The formation instruction is information for determining the shape of the light emerging from the beam forming unit 110.

The galvano scanner 113 changes the incidence angle at which the light emitted from the light source 109 is incident on the beam splitter 105. In the present embodiment, the galvano scanner 113 is a biaxial galvano scanner and is configured to direct light to an arbitrary position on the incidence plane of the beam splitter 105. The galvano scanner 113 comprises a first driving unit 114, a second driving unit 115, a first galvano mirror 116 and a second galvano mirror 117. The first galvano mirror 116 receives light emitted from the light source 109 and guides it to the second galvano mirror 117. The second galvano mirror 117 reflects the light reflected by the first galvano mirror 116 in such a manner that the reflected light is incident on the beam splitter 105. The angle of the light reflected by the first galvano mirror 116 is adjusted by the first driving unit 114. The angle of the light reflected by the second galvano mirror 117 is adjusted by the second driving unit 115. The first driving unit 114 and the second driving unit 115 are driven by a motor and are configured to change the angles of the galvano mirrors.

The beam forming unit 110 adjusts the divergence of the light emitted from the light source 109 and changes, for example, the focal distance and/or beam amount with reference to the galvano scanner 113. The beam amount is proportional to the spot diameter of the light. The beam forming unit 110 comprises, for example, an aperture lens 111 and an aperture controller 112. The aperture lens 111 is configured to change the amount of beam emitted from the light source 109 and passing therethrough in such a manner that the focal distance and the beam amount can be changed. The aperture controller 112 is configured to adjust the size of the aperture of the aperture lens 111.

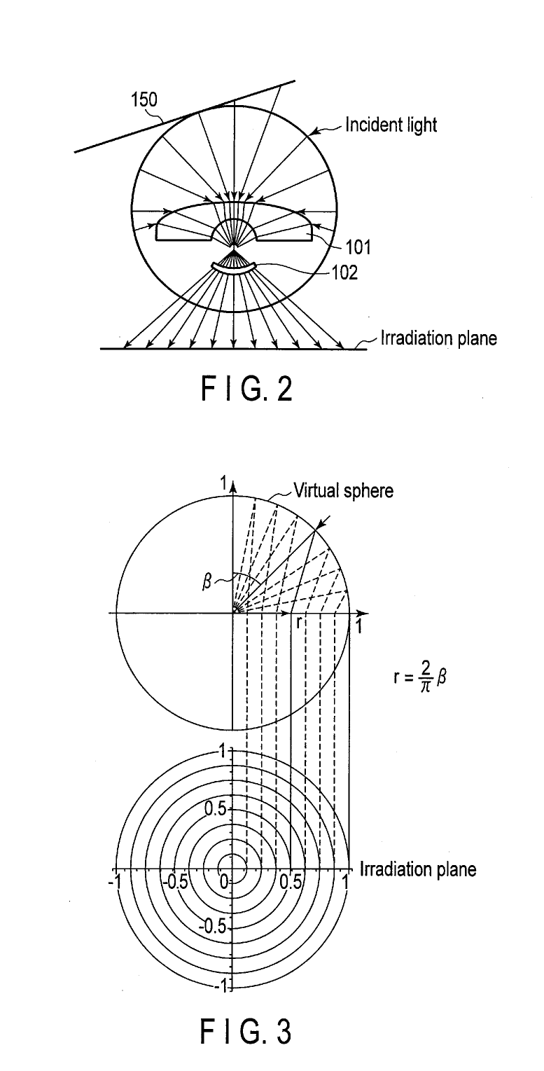

Next, a description will be given with reference to FIGS. 2, 3 and 4 as to how light is guided from the convex lens 101 to a position in the external space and what the optical characteristics the light incident on the convex lens have.

First, a description will be given with reference to FIG. 2 of the characteristics of the light which is incident on the convex lens 101 (i.e., a super-wide-angle lens such as a fish-eye lens) from the space. FIG. 2 is a diagram illustrating the optical path conversion principle of a fish-eye lens.

As shown in FIG. 2, a super-wide-angle lens is configured such that a convex lens 101 deflects and converges light and a concave lens 102 diverges and guides the light onto an irradiation plane. A variety of optical path conversion systems can be provided by combining a number of convex lenses 101 with a number of concave lenses 102. In the present embodiment, the convex lens 101 of the fish-eye lens is configured as a super-wide-angle lens having a viewing angle of 180° or more. In the following description, the super-wide-angle lens and the fish-eye lens will be collectively referred to as a wide-viewing-angle lens.

By way of example, reference will made to the equidistant projection conversion system with reference to FIG. 3. FIG. 3 illustrates the equidistant projection conversion system for a virtual sphere and represents how the incidence angle determined relative to the zenith is related to the irradiation plane.

In the equidistant projection, the convex lens 101 is designed in such a manner that in the projection conversion system the incidence angle is proportional to the distance “r” between the center of the irradiation plane and the irradiation point. In this case, the incidence angle β satisfies the following relation:

r=2β/π[radian]

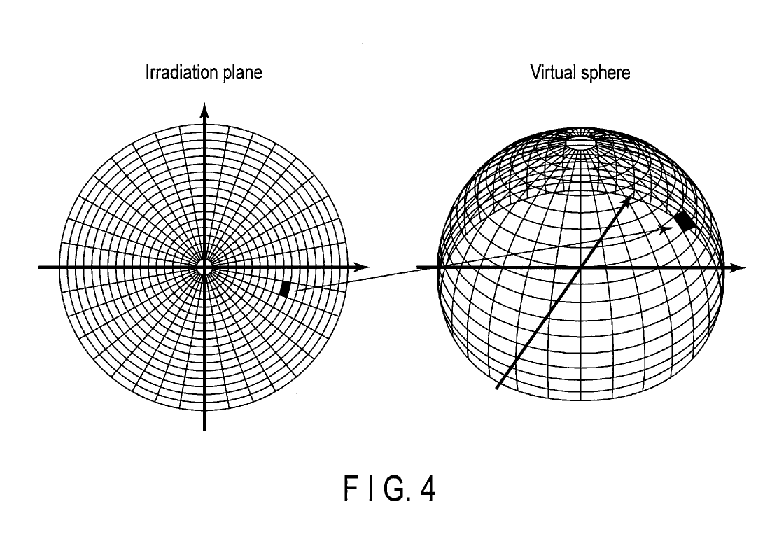

FIG. 4 illustrates how the conversion relationships of the equidistant projection conversion system are simulated as relationships where a three-dimensional virtual sphere is used for an irradiation plane. If the irradiation plane is equally divided into in the circumferential direction, the three-dimensional imaginary semi-sphere is divided likewise in the circumferential direction. Therefore, a point on the irradiation plane has a one-to-one correspondence to a point on the three-dimensional virtual sphere. The correspondence between the point on the irradiation plane and the point on the three-dimensional virtual sphere holds true not only for light incident on the irradiation plane but also for light reflected from the irradiation plane. An optical axis in an arbitrary direction of the three-dimensional space can be positioned by controlling the positioning of an arbitrary optical axis toward the irradiation plane.

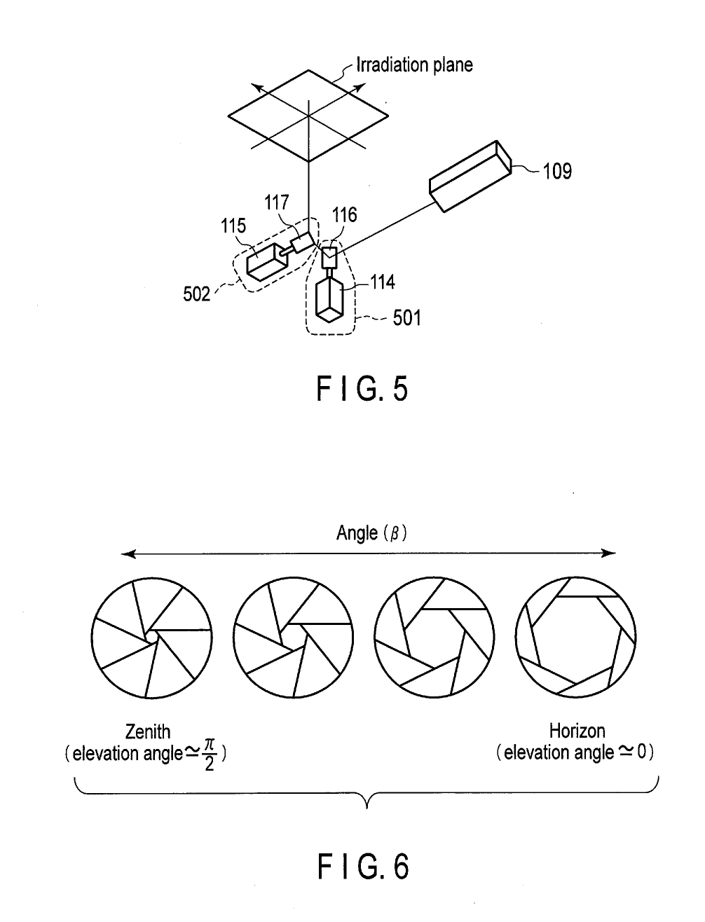

Next, a description will be given with reference to FIG. 5 of the way in which the galvano scanner positions the optical axis to the irradiation plane.

FIG. 5 is a schematic illustration of a biaxial galvano scanner. The optical axis directing apparatus of the present embodiment comprises an X mirror 501 and a Y mirror 502 which have a high degree of rotation relative to an irradiation plane. The optical axis directing apparatus of the embodiment can direct the light from the light source to an arbitrary position on the irradiation plane by rotating the first galvano mirror 116 and the second galvano mirror 117 by means of the motor or the like.

The beam forming unit 110 will be described with reference to FIG. 6.

FIG. 6 shows a diaphragm mechanism as an example of the beam forming unit, which employs diaphragm blades such as those used in a camera or other types of photographing devices. The beam forming unit 110 can change the change the size of the optical path of transmission light by changing the overlapping state of the diaphragms. In this manner, the beam forming unit 110 can shape the beam.

As explained in relation to the conversion relationships of the equidistance projection conversion system, the super-wide-angle lens undergoes projection conversion between a virtual sphere and an irradiation plane. For this reason, even if the same light beam is made to be incident on an arbitrary position on the imaginary plane, the spot diameter of the light from the virtual sphere to space may differ. For this reason, the beam forming unit 110 is used to shape the beam in accordance with the irradiation position, so that uniform light irradiation is enabled at any position in the space.

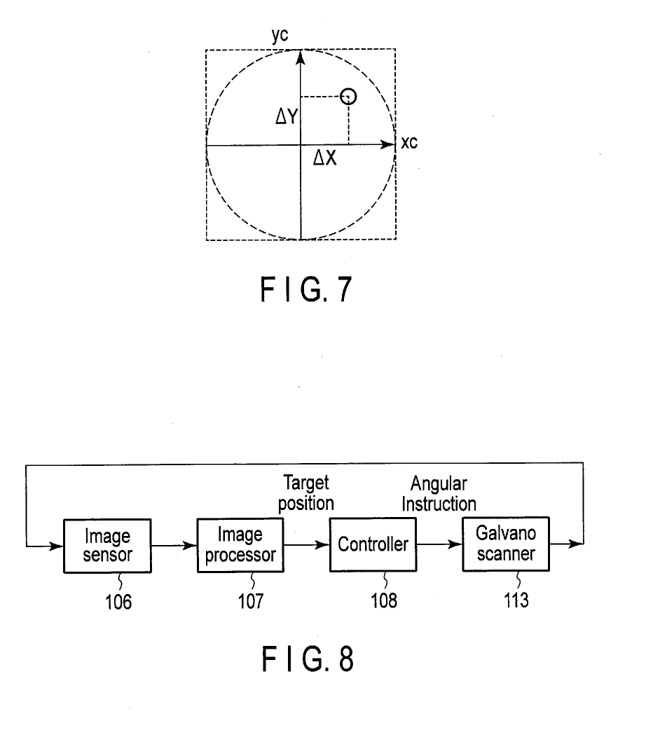

Next, a description will be given with reference to FIG. 7 of the image position information of the target, which is obtained by the image sensor 106 and the image processor 107.

FIG. 7 schematically shows an image of the target 150 photographed with the light that is incident on the image sensor 106 through the beam splitter 105. The image sensor 106 is configured to acquire an image inside the broken-line circle shown in FIG. 7. As in general image processing, the image processor 107 applies digitizing or the like to the light from the target 150 or the reflected light of the light guides by the optical axis directing apparatus, in order to extract the feature points. By calculating the position of the center of gravity of the feature points, the image processor 107 obtains the position (ΔX, ΔY) of the target as a pixel position on the sensor plane of the image sensor 106. Since the irradiation optical path from the optical axis directing apparatus and the incidence optical path from the target 150 are substantially the same, the optical axis directing apparatus can direct light to the target 150 by controlling the galvano scanner 113 to position the optical axis with reference to the target 150 detected by the image sensor 106. The optical axis relationships of the galvano scanner 113 to the image sensor 106 is uniquely determined by the configuration of the optical system. Therefore, by controlling the galvano scanner 113 to position the irradiation light to the target 150 detected by the image sensor 106, the controller 108 can perform the optical axis directing control in accordance with the light coming from the target 150 or tracking control in accordance with the movement of the target 150 if the light reflected from the target 150 is available.

A description will be given with reference to FIG. 8 as to how a system of the present embodiment incorporates the optical axis directing apparatus for directing light to the target 150.

FIG. 8 is a block diagram illustrating a control system for directing the optical axis to a moving target 150. The image sensor 106 captures an image of the target 150 by receiving either light coming from the target 150 or reflected light of the light guided by the optical axis directing apparatus. The image processor 107 extracts feature points from the image data and calculates image position information. Based on the image position information, the controller 108 generates an angular instruction for the galvano scanner, by which the optical axis is directed to an arbitrary position in a three-dimensional space. The galvano scanner 113 controls the mirror angle of the galvano scanner based on the angular instruction and directs the optical axis in an arbitrary direction.

Consideration will be given to the case where the optical axis is directed to an arbitrary position in a three-dimensional space without using the position information from the target 150. For example, the case is a case where position information is not available from the target 150 but is available from another target detecting means, the reflected light from the target 150 can be obtained by directing the optical axis to the position indicated by the second detecting means, and the optical axis directing control that tracks the moving target 150 is enabled. If, in this case, it is assumed that position information (θraz,θrel) in the spherical coordinate system can be obtained based on two angles of rotation similar to those obtained by a conventional biaxial gimbal, the positional vector (eTx,eTy,eTz) in the orthogonal coordinate system satisfies the following formulas:

eTx=cos θrel*cosθra2

eTy=cos θrel*sinθra2

eTy=cosθrel

where θraz is a r-azimuth angle, and θrel is a r-elevation angle.

In the case of the equidistance projection conversion system, the conversion of point (ΔXn,ΔYn) on the irradiation plane (corresponding to the sensor plane of the image sensor 106) to a point in the three-dimensional space (i.e., a point on the virtual sphere serving as a unit sphere), namely the conversion to a position vector (eTxn, eTyn, eTzn) performed in the orthogonal coordinate system, satisfies the following formulas:

eTxn=ΔX/(ΔX²+ΔY²)

eTyn=ΔY/(ΔX²+ΔY²)

rn=\sqrt{eTxn²eTyn²}

rdn=sin(π*rn/2)/rn

eTx=eTxn*rdn

eTy=eTyn*rdn

eTz=\sqrt{1−eTx²−eTy²}

As can be understood from the above, the projection conversion to two angles of rotation (θaz, θel) performed in the spherical coordinate system is inverse to the conversion from the spherical coordinate system to the orthogonal coordinate system and satisfies the following formulas:

r=\sqrt{eTx²+eTy²+eTz²}

θaz=tan⁻¹(eTy/eTx)

θel=tan⁻¹(eTz/\sqrt{eTx²+eTy²})

where θraz is an azimuth angle, and θrel is an elevation angle.

Even if light is available from a target, light can be guided to an arbitrary position by approximating the two angles of rotation (θaz, θel) in the spherical coordinate system calculated from point (ΔXn,ΔYn) on the irradiation plane to position information (θraz,θrel) which another detection system obtains in the spherical coordinate system at two angles of rotation.

In the embodiment described above, the galvano scanner 113 is rotated based on the image position image position information on the target 150 supplied from the image sensor 106, and the optical axis can be directed in any desired direction in the space through the super-wide-angle lens. In addition, since the incidence on the irradiation plane through the super-wide-angle lens can be optically converted into irradiation to a position in the three-dimensional space, the optical axis can be directed in any desired direction in the three-dimensional space, by use of the optical axis directing mechanism employing the galvano scanner 113 and configured only for the XY plane. Therefore, the optical axis directing apparatus of the embodiment is simpler than the conventional gimbal structure and requires a smaller driving force. Accordingly, the apparatus of the embodiment is small in size and light in weight. In addition, since the same super-wide-angle lens is used for both the irradiation system from the light source and the incidence system from the target, the coordinate system for the detection of the target position and the coordinate system for the position of the optical axis to the target can be the same. For this reason, the target can be automatically tracked and irradiated with light without performing complicated control. Furthermore, since the beam forming unit 110 is provided for light beams emitted from the light source, the light beams can be adjusted in accordance with the direction in which they are directed, and the beams emerging from the super-wide-angle lens are prevented from being undesirably widening.

The present embodiment is not limited that described above and can be modified and implemented in various manners without departing from the spirit and scope. For example, the beam forming unit is not limited to the diaphragm mechanism mentioned above and can be easily realized by a number of lenses. In addition, various modifications can be derived by properly combining the structural elements described in relation to the above embodiment. For example, some of the structural elements can be omitted, and structural elements intended for different embodiments can be combined together.

While certain embodiments have been described, these embodiments have been presented by way of example only, and are not intended to limit the scope of the inventions. Indeed, the novel apparatuses, methods and computer readable media described herein may be embodied in a variety of other forms; furthermore, various omissions, substitutions and changes in the form of the apparatuses, methods and computer readable media described herein may be made without departing from the spirit of the inventions. The accompanying claims and their equivalents are intended to cover such forms or modifications as would fall within the scope and spirit of the inventions.

1. An optical axis directing apparatus comprising:
a base;
a lens supported on the base and having a wide viewing angle;
a light source configured to generate first light;
a beam splitter configured to allow transmission of at least one of the first light traveling to the lens and second light traveling from the lens;
an image sensor configured to acquire the second light from the beam splitter and acquire an image of the second light;
an image processor configured to receive the image and calculate a position of a feature point included in the image; and
a galvano scanner configured to receive the first light and define an optical path along which the first light travels to the position through the lens.

2. The apparatus according to claim 1, further comprising a beam forming unit located between the light source and the galvano scanner and configured to adjust a spot diameter and focal length of the first light in accordance with the position.

3. The apparatus according to claim 1, wherein the lens has a viewing angle of at least 180°.

4. The apparatus according to claim 1, wherein the image processor further calculates a position vector on an orthogonal coordinate system from a first position corresponding to the position on a sensor plane of the image sensor, based on projection conversion relationships of the lens.

5. The apparatus according to claim 4, further comprising a controller configured to calculate angles of mirrors included in the galvano scanner based on the projection relationships and to control the mirrors.

6. The apparatus according to claim 1, wherein the beam splitter comprises a transflective member that allows transmission of infrared light and reflects visible light.
